(19) United States
(12) Patent Application Publication
(10) Pub. No.: US 2025/0153721 A1
(43) Pub. Date: May 15, 2025

(54) PROPULSION ARBITRATION SYSTEM

(71) Applicant: GM Global Technology Operations LLC, Detroit, MI (US)

(72) Inventors: Hafez Irshaid, Canton, MI (US); Brian Kalinowski, Livonia, MI (US)

(73) Assignee: GM Global Technology Operations LLC, Detroit, MI (US)

(21) Appl. No.: 18/509,095

(22) Filed: Nov. 14, 2023

(51) Int. Cl. B60W 50/00

(52) U.S. Cl. CPC B60W 50/00; B60W 2050/0093; B60W 2556/10

(57) ABSTRACT

A propulsion arbitration system for a vehicle includes a vehicle processor configured to store vehicle data including vehicle event data and propulsion request data. The propulsion arbitration system also includes a vehicle processor configured to store vehicle data including vehicle event data and propulsion request data. The vehicle processor is also configured to determine a priority of a propulsion request based on one or more of vehicle event data and the propulsion request data. The vehicle processor is also configured to activate a propulsion request based on the determined priority of the propulsion request data.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to a propulsion arbitration system for a vehicle.

Today's vehicles include numerous vehicle operations that enhance the drivability, safety, and/or comfort of the vehicle. For example, some vehicle operations include autonomous vehicle controls, cruise control, brake system management, and traction or drag control. Each vehicle operation requires various engine power, speed, or torque amounts depending on the type of vehicle operation requesting activation. Additionally, multiple vehicle operations may request activation simultaneously, thereby requiring the vehicle to determine which power request, speed request, or torque request to implement.

Existing vehicle torque control schemes often implement arbitration techniques that are used to determine which vehicle operation should be implemented if more than one vehicle operation is requested at the same time. Such arbitration techniques include a plurality of “IF-Else” statements that are executed consecutively to determine which request should be implemented. However, if new functions are added to the vehicle or if changes to priority of requests within the vehicle engine are needed, significant code changes are required. Moreover, as significant code changes can easily lead to error in vehicle functionality, an updated propulsion arbitration system is desired.

### SUMMARY

In one configuration, a propulsion arbitration system for a vehicle includes a vehicle processor configured to store vehicle data including vehicle event data and propulsion request data. The vehicle processor is also configured to determine a priority of a propulsion request based on one or more of vehicle event data and the propulsion request data. Additionally, the vehicle processor is configured to activate a propulsion request based on the determined priority of the propulsion request data.

The propulsion arbitration system may also include one or more of the following optional features. For example, the vehicle processor may be configured to assign each torque request a priority number. Additionally, the priority may be determined using a programmable logic array. Moreover, propulsion request data may include one or more of request status, total torque constraints, torque constraint source, and intervention type. Additionally, in some examples, the vehicle processor may also be configured to de-queue a request based on the determined priority. Moreover, a vehicle incorporates the propulsion arbitration system. Additionally, the vehicle may be an electric vehicle.

In one configuration, a propulsion arbitration system for a vehicle includes a vehicle processor configured to store data including vehicle event data, vehicle gear mode, and propulsion request data. The propulsion arbitration system also includes a vehicle processor configured to determine which set of arbitration rules to use to determine a priority of a propulsion request based on the propulsion request data and one or more of the vehicle event data and the vehicle gear mode. Additionally, the vehicle processor is configured to determine the priority of the propulsion request based on the vehicle event data, the propulsion request data, and the vehicle gear mode. Moreover, the vehicle processor is also configured to activate a propulsion request based on the determined priority of the propulsion request data.

The propulsion arbitration system may also include one or more of the following optional features. For example, the vehicle processor may be configured to assign each propulsion request a priority number. Additionally, the priority may be determined using a programmable logic array. Moreover, the propulsion request data may include one or more of request status, total torque constraints, torque constraint source, and intervention type. The propulsion request data may also include speed data. Additionally, in some examples, a vehicle incorporates the propulsion arbitration system.

In one configuration, a propulsion arbitration system for a vehicle includes a vehicle processor configured to store vehicle data including vehicle event data and propulsion request data. The vehicle processor is also configured to determine a priority of a propulsion request based on the vehicle event data including one or more of vehicle weight, vehicle speed, vehicle acceleration, or vehicle incline and the propulsion request data including one or more of request status, total torque constraints, torque constraint source, and intervention type. Determining the priority of the propulsion request includes determining if multiple propulsion requests have been made, calculating a priority of each requestor from an arbitration priority repository based on the propulsion request data, placing each requestor in order by priority in an arbitration priority queue and applying rules from an arbitration rules repository to each requestor in the arbitration priority queue to determine which request has the highest priority. The vehicle processor is also configured to activate a propulsion request based on the determined priority of the propulsion request.

The propulsion arbitration system may also include one or more of the following optional features. For example, the vehicle processor may be configured to assign each propulsion request a priority number. Additionally, priority may be determined using a programmable logic array. Moreover, the vehicle processor may also be configured to de-queue a torque request based on the determined priority. Additionally, the vehicle data may also include vehicle mode, which includes direction of intended motion. The rules which are used in the arbitration rules repository may be determined based on the direction of intended motion. Additionally, a vehicle may incorporate the propulsion arbitration system.

### BRIEF DESCRIPTION OF THE DRAWINGS

The drawings described herein are for illustrative purposes only of selected configurations and are not intended to limit the scope of the present disclosure.

FIG. 1 is a perspective exterior view of a vehicle having a propulsion arbitration system according to one aspect of the present disclosure;

FIG. 2 is an exemplary functional block diagram according to one aspect of the propulsion arbitration system as described herein;

FIG. 3A is an exemplary functional block diagram according to one aspect of the propulsion arbitration system as described herein;

FIG. 3B is an exemplary functional block diagram according to one aspect of the propulsion arbitration system as described herein;

FIG. 4 is an exemplary operational flow chart according to one aspect of the propulsion arbitration system as described herein;

FIG. 5 is an exemplary operational flow chart according to one aspect of the propulsion arbitration system as described herein; and

FIG. 6 is an exemplary operational flow chart according to one aspect of the propulsion arbitration system as described herein.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

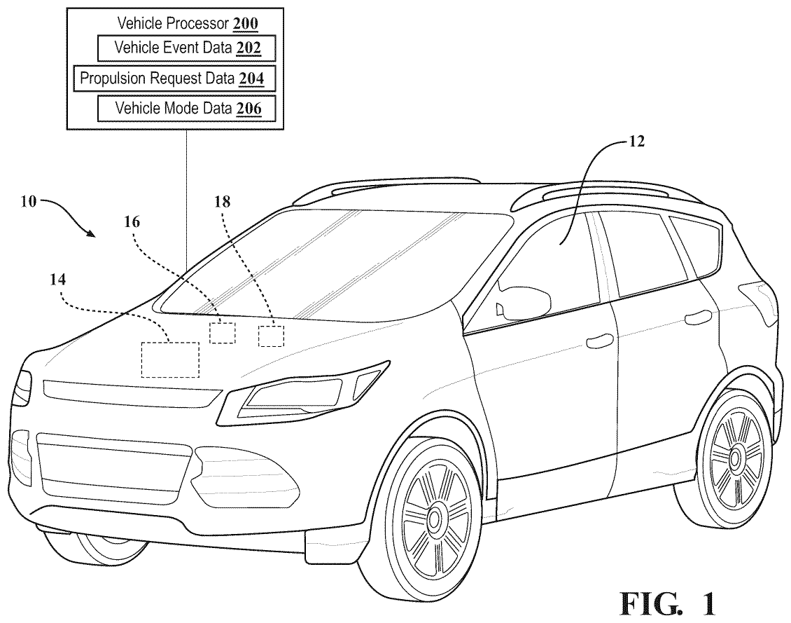

Referring now to the example shown in FIGS. 1-3, a propulsion arbitration system is illustrated at reference number 10. In some examples, such as the example shown in FIG. 1, the propulsion arbitration system 10 is incorporated into a vehicle 12. The vehicle 12 may be an electric vehicle 12 (EV) and may include autonomous or semi-autonomous capabilities. Alternatively, the vehicle 12 may be a hybrid electric vehicle (HEV) incorporating both EV and internal combustion engine (ICE) components and capabilities or could incorporate only ICE components and capabilities. While the vehicle 12 could be an EV or an HEV, the vehicle 12 will be described as incorporating only ICE components and capabilities. Accordingly, the vehicle 12 will be described and shown hereinafter and in the drawings as including an engine 14.

In some examples, the vehicle engine 14 is an ICE and includes various components configured to provide various operations requiring power for the vehicle 12. Moreover, the vehicle engine 14 is responsible for providing torque and/or speed to all vehicle operations, as needed. Many vehicle operations have different torque requirements or speed requirements to be fulfilled. Some exemplary vehicle operations that require torque or speed include, but are not limited to, driver torque request, autonomous vehicle controls including cruise control and hands-free driving, traction and/or drag control, vehicle-over-speed protection, brake system management, decel fuel cutoff, engine idle speed control, leveling control, and body control. During typical driving of the vehicle 12, many of these vehicle operations may be occurring simultaneously such that each vehicle operation will request a certain propulsion amount, called a propulsion request, from the vehicle engine 14 for operation. The propulsion amount refers to a requisite torque and/or speed required to be produced by the vehicle engine 14 that allows for implementation of the particular vehicle operation. The propulsion amount which allows for implementation of the particular vehicle operation may be sent to various vehicle subsystems for implementation. The vehicle subsystems may include one or more of an autonomous vehicle system, a brake system, a speed system, or a control system.

The propulsion arbitration system 10 also includes a vehicle processor 200 configured to store vehicle data and determine a priority of the various propulsion requests. The vehicle processor 200 may be an engine control unit (ECU) or other controller. Additionally, the vehicle processor 200 is configured to store vehicle data including vehicle event data 202, propulsion request data 204, and vehicle mode data 206. The vehicle event data 202 includes one or more of vehicle weight, vehicle speed, vehicle acceleration, and vehicle incline.

The vehicle weight generally pertains to the current weight of the vehicle 12. The vehicle weight may be impacted by vehicle passengers, objects in or on the vehicle, and/or objects being towed by the vehicle 12. The vehicle weight may be gathered, sensed, measured, and/or calculated from one or more vehicle sensors 16 and/or cameras 18.

The vehicle speed generally pertains to a current speed of the vehicle 12. The vehicle speed may be gathered, sensed, measured, and/or calculated from one or more vehicle sensors and/or cameras. In some examples, the vehicle speed generally pertains to a speed of the vehicle engine 14. More specifically, in some examples, the vehicle speed is represented as “revolutions per minute” or RPM and represents the number of times a crankshaft of the engine 14 makes a full rotation every 60 seconds. In some examples, the RPM is displayed on a vehicle dashboard in addition to being stored in the vehicle processor 200. The processor 200 may use the vehicle speed over time to calculate the current vehicle acceleration. Additionally, it is contemplated that the vehicle speed may be constantly changing such that the vehicle speed and/or vehicle acceleration may be continually sensed and/or gathered during vehicle operations.

The vehicle incline generally pertains to the angle of incline of the vehicle 12. The angle of incline may affect the amount of torque the vehicle 12 must produce for a given vehicle operation. For example, if the vehicle 12 is traveling up a hill, the vehicle 12 will require more torque as compared to the vehicle 12 traveling the same distance on a flat road with zero (0) incline. The angle of incline may be sensed, measured, gathered, and/or calculated by vehicle sensors and/or vehicle cameras.

The vehicle mode data 206 generally pertains to the current mode of the vehicle 12. For example, the current mode may be one or more of Drive, Neutral, Reverse, or the like. Additionally or alternatively, the vehicle mode data 206 may generally pertain to whether an autonomous vehicle mode is activated (e.g., cruise control, hands-free driving). The current mode of the vehicle 12 may be sensed, measured, gathered, and/or calculated by vehicle sensors and/or vehicle cameras.

The propulsion request data 204 generally pertains to any data related to the propulsion request. The propulsion request data 204 may include one or more of request status, total torque constraints, torque constraint source, speed request, and intervention type. The request status generally pertains to whether the propulsion request, such as a torque or speed request, has been executed already. Additionally, the total torque constraints generally pertain to the total amount of torque requested. The torque constraint source generally pertains to the location or source that the torque is desired.

The speed request may generally pertain to a desired RPM of the vehicle engine 14 which, in turn, pertains to the speed of the vehicle 12. The speed request may include the amount of speed requested, the location of the speed request, and/or speed interventions. In some examples, the speed interventions may include modifying other sources, such as an acceleration pedal, to compensate for the speed request. Additionally, the intervention type generally pertains to interventions the vehicle processor 200 will have to undertake to deliver the torque request to the desired source. In some examples, interventions may include removing or adding torque or speed to other sources to compensate for the request. The interventions may be one of no intervention, maximum intervention, minimum intervention, or between the maximum intervention and the minimum intervention. The propulsion request data 204 may be sensed, measured, gathered, and/or calculated by the vehicle sensors 16 or may be pre-determined for each torque requestor.

The vehicle processor 200 is configured to determine a priority of the propulsion request based on the vehicle event data 202 and the propulsion request data 204. Generally, the vehicle processor 200 primarily utilizes a rule-based arbitration technique that relies on pre-defined rules and a pre-defined arbitration priority table. These rules and priority table may be stored in a centralized repository, such as an arbitration rules repository. First, each possible requestor is assigned to an arbitration rule and priority value. This rule may be stored as a programmable logic array (PLA) format that is evaluated and executed to determine if this requestor has the highest priority or not. The priority for each requestor determines the priority position inside the arbitration priority queue. This technique provides the capability of dynamically changing the arbitration rules and priority without altering the existing code set. Similarly, rules and priorities can be amended during vehicle development or after sale via over-the-air updates.

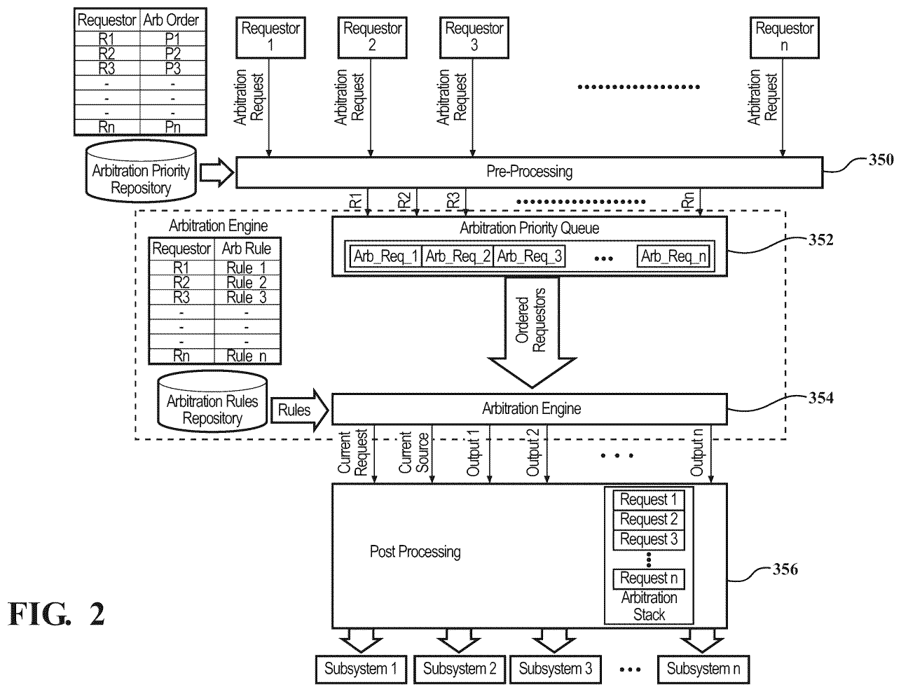

More specifically, as illustrated in FIG. 2, each request is assigned to an input buffer that holds information such as the propulsion request data 204. While the propulsion request data 204 for each requestor is being stored in the buffer, the vehicle processor 200 is configured to pre-process the inputs of each requestor to assign a priority in the arbitration priority queue at step 350. More specifically, the pre-processing may include reading or calculating the requestor's priority from the known arbitration priority repository and placing the request in the right place inside the arbitration priority queue.

After placing all requestors in the appropriate order based on the arbitration priority repository, the repository stores information about each requestor and its priority in the arbitration priority queue. In some examples, the information is stored as data pairs, e.g., (Requestor, Priority). Once the information is stored, each request will be placed in order based on the pre-defined priority inside the arbitration priority repository at step 352. The priority indicates the location in line in which the request will be arbitrated by the vehicle processor 200.

In some examples, the vehicle processor 200 stores rules in the arbitration rules repository in programmable logic array (PLA) format. The PLA has a set of programmable AND gate planes, which link to a set of programmable OR gate planes, which can then be conditionally complemented to produce an output. Additionally, in some examples, the second plane includes all possible logical operations, including greater than (>), less than (<), greater than or equal (>=), less than or equal (<=), equal (==), and not equal (!=). Additionally, in some examples, the third plane includes AND, OR operations. The vehicle processor 200 is configured to create the connections between the input buffer, logical operations planes, and the AND/OR planes to create the appropriate logic. The vehicle processor 200 may then read the output of the PLA after the execution to determine which request should be activated.

Additionally, the vehicle processor 200 may de-queue requests based on the priority determination. In some examples, all requests are de-queued until the vehicle processor 200 gathers the priority queue and gathers the associated arbitration rule from the rules repository. At this point, the vehicle processor 200 executes the arbitration rule at step 354. Based on the result, the vehicle processor 200 will decide if this requestor is the highest priority request.

Referring still to FIG. 2, once it has been determined which propulsion request should be activated, the amount of torque or speed needed to execute the propulsion request is determined and stored in a post-processing step at 356. Then, the vehicle processor 200 is configured to execute the propulsion request by commanding the desired torque or speed of the engine 14 to each of the vehicle subsystems. In some examples, the vehicle processor 200 may also be configured to de-queue a propulsion request based on the determined priority. For example, if a specific propulsion request is not the top priority request, the vehicle processor 200 may be configured to de-queue all non-top priority requests. However, in some examples, if a specific propulsion request is not the top priority request, the vehicle processor 200 may be configured to store that information and execute the secondary priority propulsion requests at a later time.

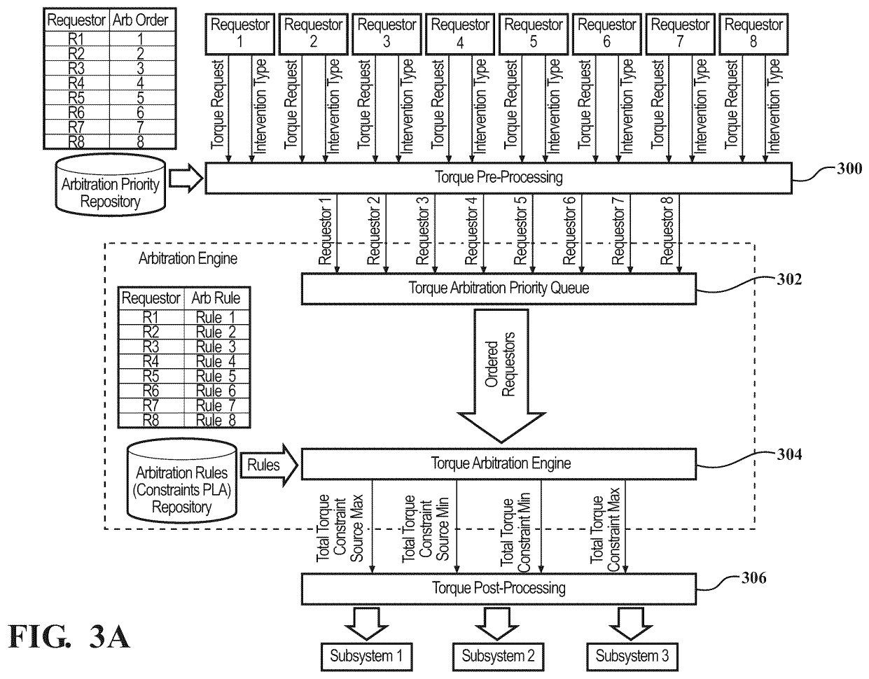

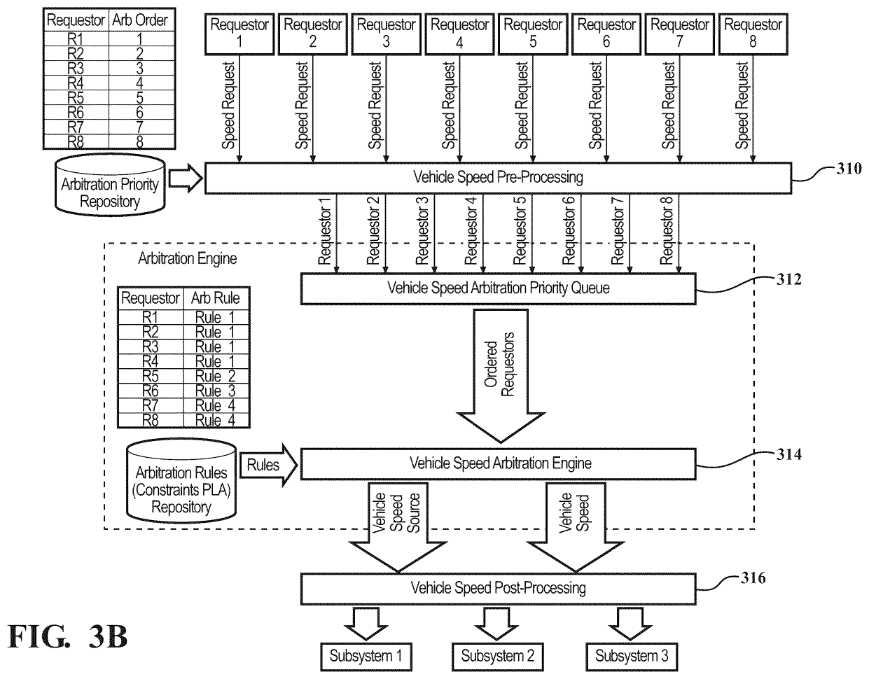

For example, as shown in FIG. 3A, the request may be a torque request. A torque pre-processing step includes input of the requestor information including torque request amount and intervention type at 300. The vehicle processor 200 uses the propulsion request data 204 such as the torque request amount and intervention type to read or calculate priority of each torque request from the arbitration priority repository at step 300. The vehicle processor 200 then places each torque request in the correct order inside the arbitration priority queue at step 302. The torque requests are then assigned a priority based on the arbitration rules repository for each torque request in the priority queue at step 304. Once the highest priority request has been determined, the applicable toque is applied to the desired subsystem in the torque post-processing step at step 306.

For example, as shown in FIG. 3B, the request may be a speed request. A speed pre-processing step includes input of all the requestor information for each request at 310. The vehicle processor 200 uses the propulsion request data 204 such as the speed request amount to read or calculate priority of each speed request from the arbitration priority repository at step 310. The vehicle processor 200 then places each speed request in the correct order inside the arbitration priority queue at step 312. The speed requests are then assigned a priority based on the arbitration rules repository for each speed request in the priority queue at step 314. Once the highest priority request has been determined, the applicable speed is applied to the desired subsystem in the speed post-processing step at step 316.

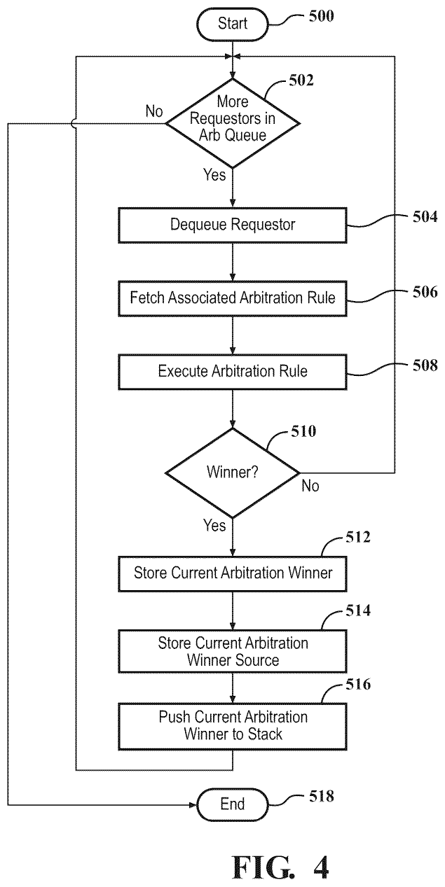

Referring now to the example shown in FIG. 4, the vehicle 12 begins operation at step 500. During vehicle operations, the vehicle processor 200 receives torque requests from various sources and determines if there is more than one torque request at step 502. If there is more than one request, the vehicle processor 200 then de-queues all requests at step 504. The vehicle processor 200 fetches the priority of each torque request from the priority repository at step 506. At step 508, the vehicle processor 200 then executes the arbitration rule by placing each of the requests in the arbitration queue based on their priority. At step 510, the vehicle processor 200 determines the highest priority request using the arbitration rules repository. Request data 204 including the type of request and the source of the request are stored at steps 512 and 514. The winning request is activated at step 516 and the process is repeated. If there are no more requests, the operation ends at step 518. More specifically, if the propulsion arbitration system 10 is activated, a first torque request is received for a first operation such as traction control and a second torque request is received for brake torque management. The vehicle processor 200 will de-queue both torque requests while determining which torque request has the highest priority. The vehicle processor 200 will retrieve the priority information from the priority repository for both the traction control request, and the brake torque management request. The vehicle processor 200 will then place the brake torque management at the highest priority based on the arbitration rules repository and activate the brake torque management request. The vehicle event data 202 including the torque constraint and the torque constraint source are also stored in the vehicle processor 200.

Additionally, the vehicle processor 200 may use the vehicle mode data 206 to determine which propulsion request should be activated. The vehicle mode data 206 may be used to determine the direction of the intended motion of the vehicle 12. The direction of the intended motion of the vehicle 12 may change the priority of the propulsion request. For example, if the vehicle 12 is in Reverse, the vehicle processor 200 may override priority of forward direction torque requests. Additionally or alternatively, the vehicle processor 200 may determine which arbitration rule set to use to determine which propulsion request should be activated based on the vehicle mode data 206 and/or the vehicle event data 202. For example, arbitration rule sets may vary based on whether the vehicle is in Reverse or Drive modes and the vehicle processor 200 is configured to determine which arbitration rule set to apply based on the mode of the vehicle (i.e., whether the vehicle is in a Reverse mode or a Drive mode).

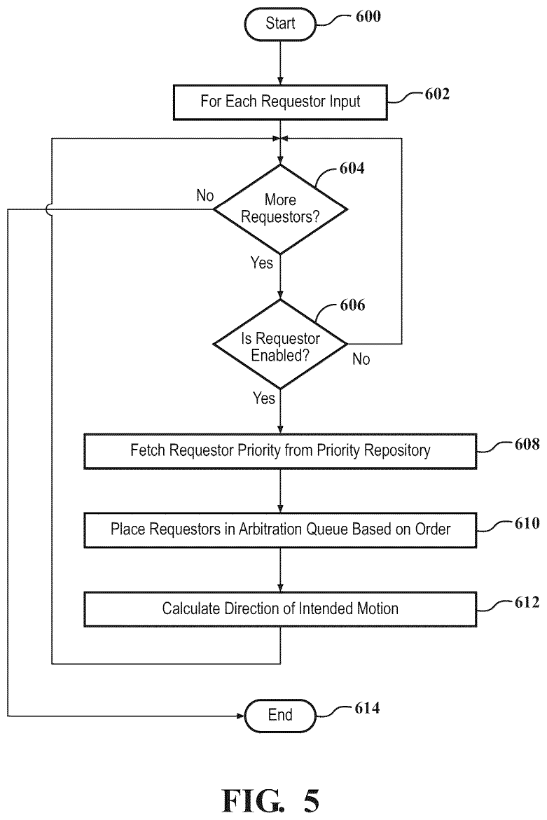

Referring now to the example shown in FIG. 5, the vehicle 12 begins operation at step 600. During vehicle operations, the vehicle processor 200 receives a request from a source at step 602. The vehicle processor 200 determines if there is more than one request at step 604. The vehicle processor 200 then determines if the requestor is enabled at step 606. If the requestor is enabled, the vehicle processor 200 fetches the priority of each request from the priority repository at step 608. At step 610, the vehicle processor 200 then places each of the requests in the arbitration queue based on their priority in the arbitration priority repository. Additionally, at step 612, the vehicle processor 200 determines the direction of intended motion and determines which rules from the arbitration rules repository should be used based on the calculated direction of intended motion. The request with the highest priority request is then activated and the vehicle processor 200 continues to receive new requests to repeat the process. For example, during operation, a first request is received for a first operation such as traction control and a second request is received for brake torque management. The vehicle processor 200 will retrieve the priority information from the priority repository for both the traction control request and the brake torque management request. The vehicle processor 200 will then place the brake torque management at the highest priority based on the arbitration rules repository and calculate the direction of intended motion. If the vehicle 12 has a forward direction of intended motion, the brake torque management will remain at the highest priority and the request will be activated.

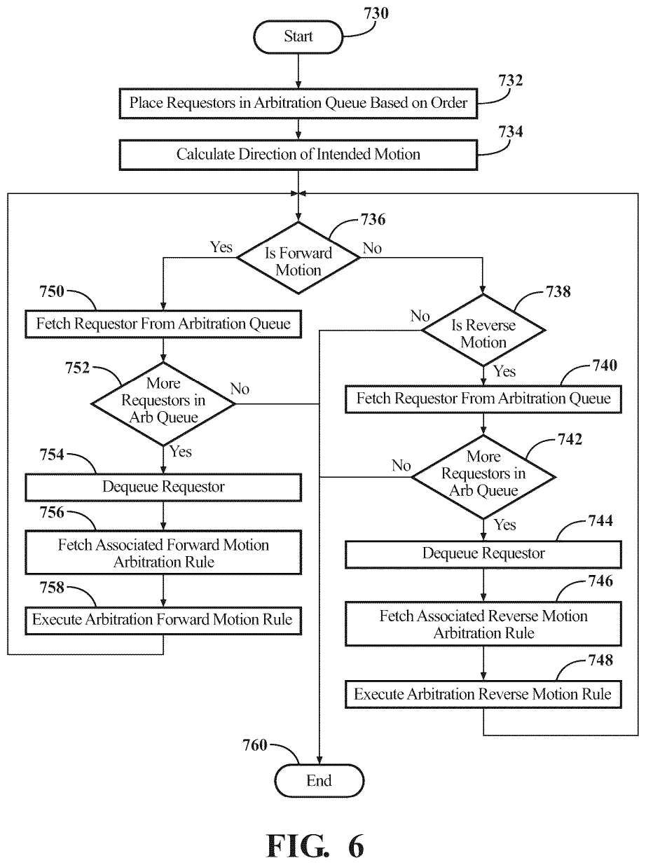

Referring now to the example shown in FIG. 6, the vehicle begins operation at step 730. Once the requestors are placed in the arbitration que based on the determined order at step 732, the vehicle processor 200 may also calculate the direction of the intended motion at step 734. If it is determined that forward motion is intended at step 736, the vehicle processor 200 then fetches the requestor from the arbitration queue at step 750 and determines if there are more requestors making requests at step 752. If there are more requestors, the vehicle processor 200 is configured to de-queue the requestors at step 754 and fetch the associated forward motion arbitration rule at step 756 before executing the forward motion arbitration rule at step 758. However, if it is determined that reverse motion is intended at step 736, the vehicle processor 200 then fetches the requestor from the arbitration queue at step 742 and determines if there are more requestors making requests at step 742. If there are more requestors, the vehicle processor 200 is configured to de-queue the requestors at step 744 and fetch the associated rearward motion arbitration rule from the arbitration rules repository at step 746 before executing the rearward motion arbitration rule at step 748. If the vehicle 12 is not in forward motion or reverse motion, or there are no additional requests in the arbitration queue, the system ends at step 760.

Vehicle operations require various power or torque amounts depending on the type of vehicle operation. Sometimes, multiple vehicle operations are active, simultaneously requiring the vehicle 12 to determine which of the various vehicle operations to prioritize. The propulsion arbitration system 10 as described herein reduces complexity of implantation and provides a standard technique to arbitrate propulsion requests among multiple requestors to determine a winner. The propulsion arbitration system 10 as described herein also provides a centralized place for arbitration rules and priorities.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A propulsion arbitration system for a vehicle, the propulsion arbitration system comprising:
a vehicle processor configured to:
store vehicle data including vehicle event data and propulsion request data;
determine a priority of a propulsion request based on one or more of the vehicle event data and the propulsion request data; and
activate a propulsion request based on the determined priority of the propulsion request data.

2. The propulsion arbitration system of claim 1, wherein the vehicle processor is configured to assign each request a priority number.

3. The propulsion arbitration system of claim 1, wherein the priority is determined using a programmable logic array.

4. The propulsion arbitration system of claim 1, wherein the propulsion request data includes one or more of request status, total torque constraints, torque constraint source, and intervention type.

5. The propulsion arbitration system of claim 1, wherein the vehicle processor is also configured to de-queue a request based on the determined priority.

6. A vehicle incorporating the propulsion arbitration system of claim 1.

7. The vehicle of claim 6, wherein the vehicle is an electric vehicle.

8. A propulsion arbitration system for a vehicle, the propulsion arbitration system comprising:
a vehicle processor configured to:
store data including vehicle event data, vehicle gear mode, and propulsion request data; and
determine which set of arbitration rules to use to determine a priority of a propulsion request based on the propulsion request data and one or more of the vehicle event data and the vehicle gear mode;
determine the priority of the propulsion request based on the vehicle event data, the propulsion request data, and the vehicle gear mode; and
activate a propulsion request based on the determined priority of the propulsion request data.

9. The propulsion arbitration system of claim 8, wherein the vehicle processor is configured to assign each propulsion request a priority number.

10. The propulsion arbitration system of claim 8, wherein the priority is determined using a programmable logic array.

11. The propulsion arbitration system of claim 8, wherein the propulsion request data includes one or more of request status, total torque constraints, torque constraint source, and intervention type.

12. The propulsion arbitration system of claim 8, wherein the propulsion request data includes speed data.

13. A vehicle incorporating the propulsion arbitration system of claim 8.

14. A propulsion arbitration system for a vehicle, the propulsion arbitration system comprising:
a vehicle processor configured to:
store vehicle data including vehicle event data and propulsion request data; and
determine a priority of a propulsion request based on the vehicle event data including one or more of vehicle weight, vehicle speed, vehicle acceleration, or vehicle incline and the propulsion request data including one or more of request status, total torque constraints, torque constraint source, and intervention type, wherein determining the priority of the propulsion request includes:
determining if multiple propulsion requests have been made;
calculating a priority of each requestor from an arbitration priority repository based on the propulsion request data;
placing each requestor in order by priority in an arbitration priority queue; and
applying rules from an arbitration rules repository to each requestor in the arbitration priority queue to determine which request has the highest priority; and
activate a propulsion request based on the determined priority of the propulsion request.

15. The propulsion arbitration system of claim 14, wherein the vehicle processor is configured to assign each propulsion request a priority number.

16. The propulsion arbitration system of claim 14, wherein the priority is determined using a programmable logic array.

17. The propulsion arbitration system of claim 14, wherein the vehicle processor is also configured to de-queue a torque request based on the determined priority.

18. The propulsion arbitration system of claim 14, wherein the vehicle data also includes vehicle mode data which includes a direction of intended motion.

19. The propulsion arbitration system of claim 1, wherein the rules applied from the arbitration rules repository are based on the vehicle mode data.

20. A vehicle incorporating the propulsion arbitration system of claim 14.
